(19) United States
(12) Patent Application Publication
(10) Pub. No.: US 2010/0308115 A1
(43) Pub. Date: Dec. 9, 2010

(54) Laser barcode scanner and an execution method thereof

(75) Inventor: Kenneth Liou, Hsin-Tien City (TW)

Correspondence Address: Muncy, Geissler, Olds & Lowe, PLLC, 4000 Legato Road, Suite 310, FAIRFAX, VA, 22033, US

(73) Assignee: MARSON Technology Co., Ltd.

(21) Appl. No.: 12/068,542

(22) Filed: Feb. 7, 2008

(51) Int. Cl. G06K 7/14

(52) U.S. Cl. 235/462.22

(57) ABSTRACT

A laser barcode scanner and its execution method apply a ranging method by light to quickly measure a distance between the laser barcode scanner and a barcode, and using a signal processor for computing and converting signals, to automatically control a rotation angle of a rotating device, such that a width of a scanning light emitted by the laser barcode scanner can be adjusted at any time automatically. Therefore, when being used at a different distance, a proper intensity and width of the scanning light can be adjusted automatically dependent on the distance, so as to largely improve an access efficiency of the laser barcode scanner.

### BACKGROUND OF THE INVENTION

a) Field of the Invention

The present invention relates to a laser barcode scanner and an execution method thereof which use a ranging method by light to measure a distance between a laser barcode scanner and a barcode, with a width of a scanning light being adjusted automatically, so as to improve an access distance.

b) Description of the Prior Art

A laser barcode scanner uses primarily a laser diode to generate a laser point source which is changed into a line of light after being projected on a reflecting mirror or prism being able to swing back and forth. After the light is projected on a barcode of a product, the light which is reflected from the barcode is detected by a photo diode, and is then converted into an electronic signal to determine data represented by the barcode.

However, as a swing angle of the conventional reflecting mirror or prism is fixed, a width of the scanning light is also fixed. When using the laser barcode scanner to scan the barcode, a distance between the laser barcode scanner and the barcode is usually different depending on a condition of usage. Yet, as an illuminating angle of the scanning light is fixed, when the distance between the laser barcode scanner and the barcode is getting farther, the width of the scanning light is getting larger too. Referring to FIG. 1, it shows a schematic view upon using a conventional laser barcode scanner. As shown in the drawing, when the conventional laser barcode scanner 10 is scanning barcodes 20 at different distances l1, l2, widths w1, w2 of a scanning light 30 will not be changed following a swing angle θ of a reflecting mirror or prism. It can be shown from FIG. 1 that as a distance of the laser barcode scanner 10 between the barcodes 20 gets farther (l2>l1), the width of the scanning light 30 gets larger (w2>w1) too. In addition, in comparison with the scanning light 30 at a short distance, an intensity of the scanning light will be weakened correspondingly. Therefore, it is possible that data of the barcodes 20 cannot be determined, and for the scanning light 30 that is too close, it is possible to limit an access distance of the conventional laser barcode scanner 10 due to power consumption, price, and safety.

### SUMMARY OF THE INVENTION

Accordingly, in view of that when using the conventional laser barcode scanner, the width and the intensity of the scanning light will be usually affected, and even the access distance and precision can be affected, due to the effect of the distance, a brand new laser barcode scanner and an execution method thereof are designed by the present inventor.

The primary object of the present invention is to provide a laser barcode scanner and an execution method thereof, wherein the intensity and the width the scanning light can be adjusted automatically, thereby improving the access efficiency.

Accordingly, the laser barcode scanner of the present invention includes primarily a housing, a rotating device, a reflecting mirror or prism, a first light emitter, a first light receiver and a signal processor, wherein a front surface of the housing is formed with a through-hole, the rotating device is assembled inside the housing, and the reflecting mirror or prism is assembled on the rotating device to rotate back and forth along with the rotating device; whereas the first light emitter is assembled at a rear side of the reflecting mirror or prism to emit light and generate an electronic signal, with the light also being used to measure a distance and scan, the first light receiver is assembled at a side of the light emitter to receive the light which is reflected by a barcode and to generate an electronic signal, the signal processor is assembled at a side of the light emitter and links data with the first light emitter, the first light receiver, and the rotating device, such that the electronic signals of the first light emitter and the first light receiver can be inputted into the signal processor for computing an electronic signal related to the distance, thereby driving the rotating device to rotate the reflecting mirror or prism back and forth by this electronic signal.

On the other hand, upon using the laser barcode scanner, following steps are included: a first step—emitting a ranging light, a ranging light is emitted to the barcode by the first light emitter through the reflecting mirror or prism, and an electronic signal is issued to the signal processor, then, when the light hits the barcode, the aforementioned ranging light will be reflected immediately; a second step—receiving the ranging light, the aforementioned ranging light, which has been reflected by the barcode, can be received by the first light receiver (photo diode), and an electronic signal is similarly issued to the signal processor; a third step—computing the distance and converting the signals, after the signal processor has received the electronic signals of the first light emitter and the first light receiver, a distance-related information between the barcode and the laser barcode scanner will be computed and converted into an electronic signal representing a time difference between the two electronic signals; a fourth step—defining a swing angle, after the aforementioned distance-related electronic signal has been inputted into the rotating device, a value of a rotation angle of the rotating device can be defined to control the angle at which the rotating device is rotating back and forth; whereas, a swing angle of the reflecting mirror or prism which is assembled on the rotating device will also be diminished gradually along with the distance; a fifth step—emitting a scanning light, a light is emitted by the first light emitter again, and is projected on the reflecting mirror or prism which swings back and forth; whereas, a scanning light of a proper width is generated on the barcode, with the width of the scanning light being changed dependent on the swing angle; and a sixth step—receiving the scanning light, the scanning light which has been reflected through the barcode can be received again by the first light receiver to access a barcode data.

Accordingly, the width of the scanning light can be adjusted automatically, depending on the distance between the barcode and the laser barcode scanner. Therefore, even the distance to the barcode is quite far, the width of the scanning light will be decreased automatically, such that a sufficient intensity of the scanning light can be still kept, thereby effectively improving the access distance.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a schematic view upon using a conventional laser barcode scanner.

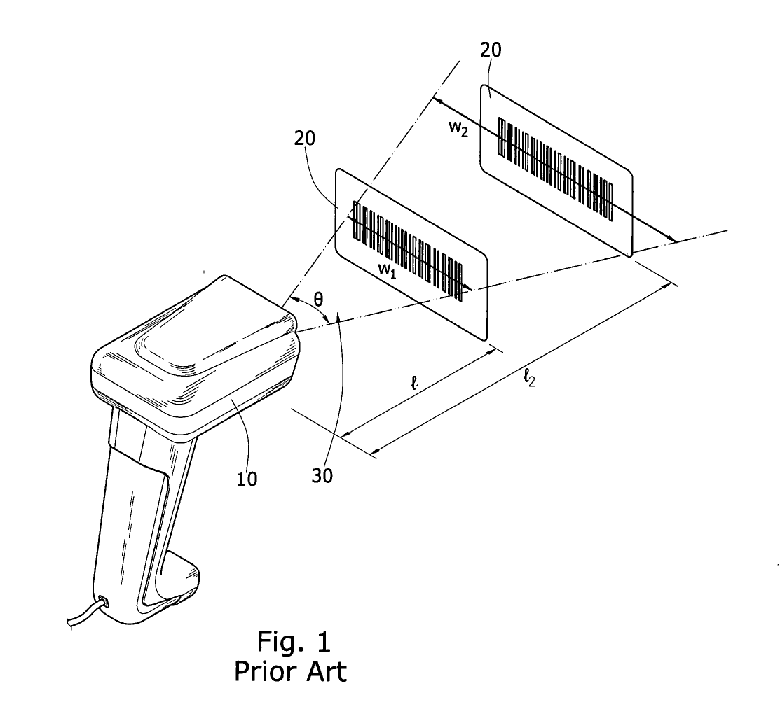

FIG. 2 shows a schematic view upon using a preferred embodiment of the present invention.

FIG. 3 shows a hardware block diagram of a preferred embodiment of the present invention.

FIG. 4 shows a flow diagram of steps of a preferred embodiment of the present invention.

FIG. 5 shows a hardware block diagram of another preferred embodiment of the present invention.

FIG. 6 shows a flow diagram of steps of another preferred embodiment of the present invention.

FIG. 7 shows a schematic view upon using another preferred embodiment of the present invention.

### DETAILED DESCRIPTION OF THE PREFERRED EMBODIMENTS

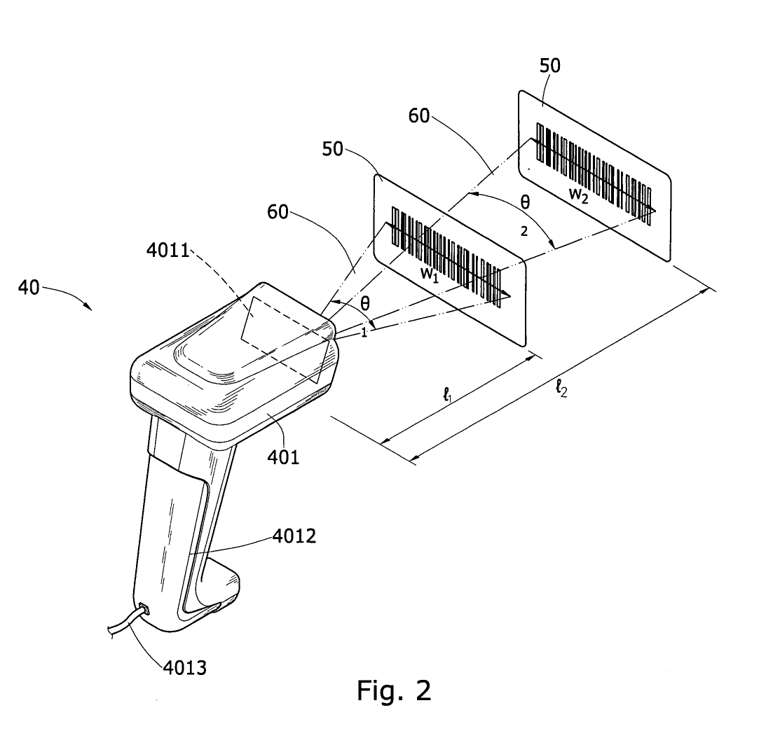

Referring to FIG. 2, it shows a schematic view upon using a preferred embodiment of the present invention. An ordinary laser barcode scanner 40 is divided into a hand-held type and a seat type, and this embodiment uses a hand-held laser barcode scanner 40 as an example, wherein a front surface of a housing 401 is formed with a through-hole 4011 and a handle 4012 for gripping by a user. In addition, a bottom of the housing 401 is assembled with a connection line 4013 for data linking with a computer or inventory equipment. When the user operates the hand-held laser barcode scanner 40, he or she can use the hand-held laser barcode scanner 40 to emit a ranging light and a scanning light 60 which is received again after being reflected by a barcode 50. In the present invention, a distance is measured in advance by the ranging light, and then a width w1, w2 of the scanning light 60 is changed when scanning the barcode 50 at a various distance l1, l2. In addition, as the distance from the laser barcode scanner 40 to the barcode 50 gets smaller (or l2>l1), the width of the scanning light 60 will get smaller (w1>w2), too. Therefore, an intensity of the scanning light 60 will not be weakened by an increase of the distance, thereby largely improving an operation distance in accessing the barcode 50.

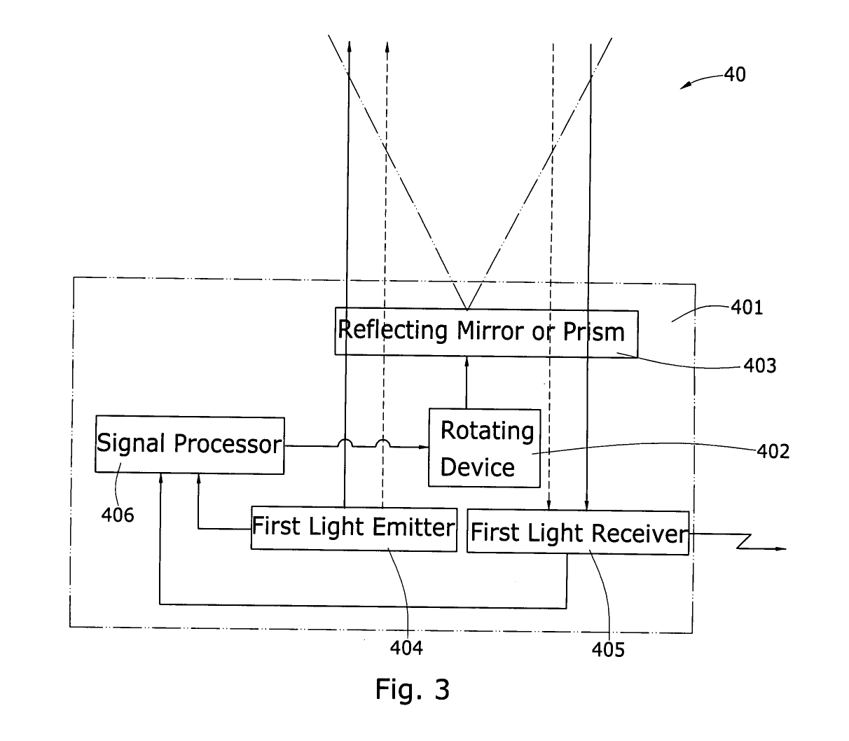

Referring to FIG. 3, it shows a hardware block diagram of a preferred embodiment of the present invention, wherein the aforementioned laser barcode scanner 40 includes primarily the housing 401; a rotating device 402, which is assembled inside the housing 401 and can generate power to rotate back and forth; a reflecting mirror or prism 403, which is assembled on the aforementioned rotating device 402 to rotate back and forth along with the rotating device 402, and is provided with a light refraction effect to refract light from a same direction into the light at a different angle; a first light emitter 404, which is assembled at a rear side of the reflecting mirror or prism 403, can be an ordinary laser point source or an infrared source to emit a ranging light and a scanning light, and can generate an electronic signal when the first light emitter 404 emits the ranging light; a first light receiver 405, which is assembled at a side of the first light emitter 404, is a photo diode, is used to receive the aforementioned ranging light or scanning light reflected by the barcode 50, generates an electronic signal, and decodes the barcode 50; and a signal processor 406, which is assembled at a side of the first light emitter 404 and links data with the first light emitter 404, the first light receiver 405, and the rotating device 402, such that after the electronic signals that are generated by the first light emitter 404 and the first light receiver 405 are inputted into the signal processor 406 for computing, the distance-related information can be measured and converted into an electronic signal for driving the rotating device 402 to rotate the reflecting mirror or prism 403 back and forth, enabling the first light emitter 404 to emit the scanning light again. When the scanning light is projected on the reflecting mirror or prism 403, as the reflecting mirror or prism 403 is rotating back and forth, the refracted light will form the line-shape scanning light 60 as described before, on a surface of the barcode 50, and change depending on an angle at which the reflecting mirror or prism 403 is rotating back and forth. At a same time, a width of the aforementioned scanning light 60 will change correspondingly. A primary design of the present invention is that when the distance is farther, the width of the scanning light 60 will be smaller, to keep an intensity of the aforementioned scanning light 60 that is projected on the barcode 50, and thus effectively improve the distance for accessing the barcode 50. On the other hand, a circuit device of the aforementioned laser barcode scanner 40 can be also assembled with a light intensity compensation IC (Integrated Circuit; not shown in the drawing), such that when the operating distance is farther, the first light emitter 404 can be activated to emit light compensation by using a pre-built parametric value of the light intensity compensation IC, to keep an effective operation. On the contrary, if the distance is too close, the light intensity of the first light emitter 404 can be adjusted by the pre-built parametric value of the light intensity compensation IC, to save the power.

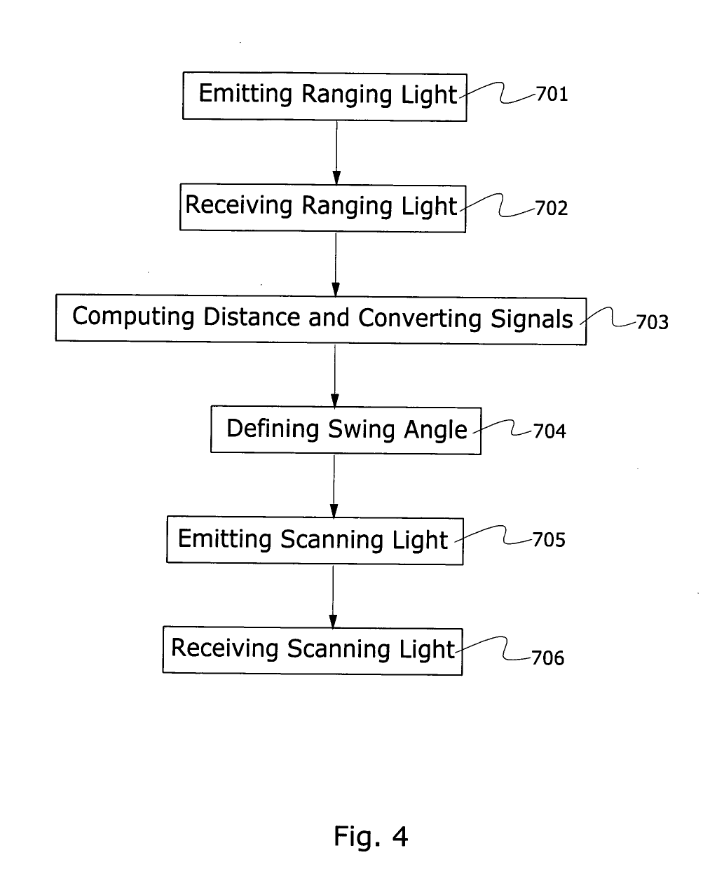

Referring to FIG. 4, it shows a flow diagram of steps of a preferred embodiment of the present invention, wherein upon using the aforementioned laser barcode scanner 40, following steps are included:

A first step 701—emitting a ranging light, a ranging light is emitted to the barcode by the first light emitter, and an electronic signal is issued to the signal processor, then, when the light hits the barcode, the aforementioned ranging light will be reflected immediately;

A second step 702—receiving the ranging light, the aforementioned ranging light, which has been reflected by the barcode, is received by the first light receiver, and an electronic signal is similarly issued to the signal processor;

A third step 703—computing the distance and converting the signals, after the signal processor has received the electronic signals of the first light emitter and the first light receiver, a distance-related information between the barcode and the laser barcode scanner will be computed, and converted into an electronic signal representing a time difference between the two electronic signals;

A fourth step 704—defining a swing angle, after the aforementioned distance-related electronic signal has been inputted into the rotating device, a value of a rotation angle of the rotating device can be defined to control the angle at which the rotating device is rotating back and forth; whereas, a swing angle of the reflecting mirror or prism which is assembled on the rotating device will also be diminished gradually along with the distance;

A fifth step 705—emitting a scanning light, a light for scanning the barcode is emitted by the first light emitter again, and is projected on the reflecting mirror or prism which swings back and forth; whereas, a scanning light of a proper width is generated on the barcode, with the width of the scanning light being changed dependent on the swing angle; and

A sixth step 706—receiving the scanning light, the scanning light which has been reflected through the barcode can be received again by the first light receiver to access a barcode data.

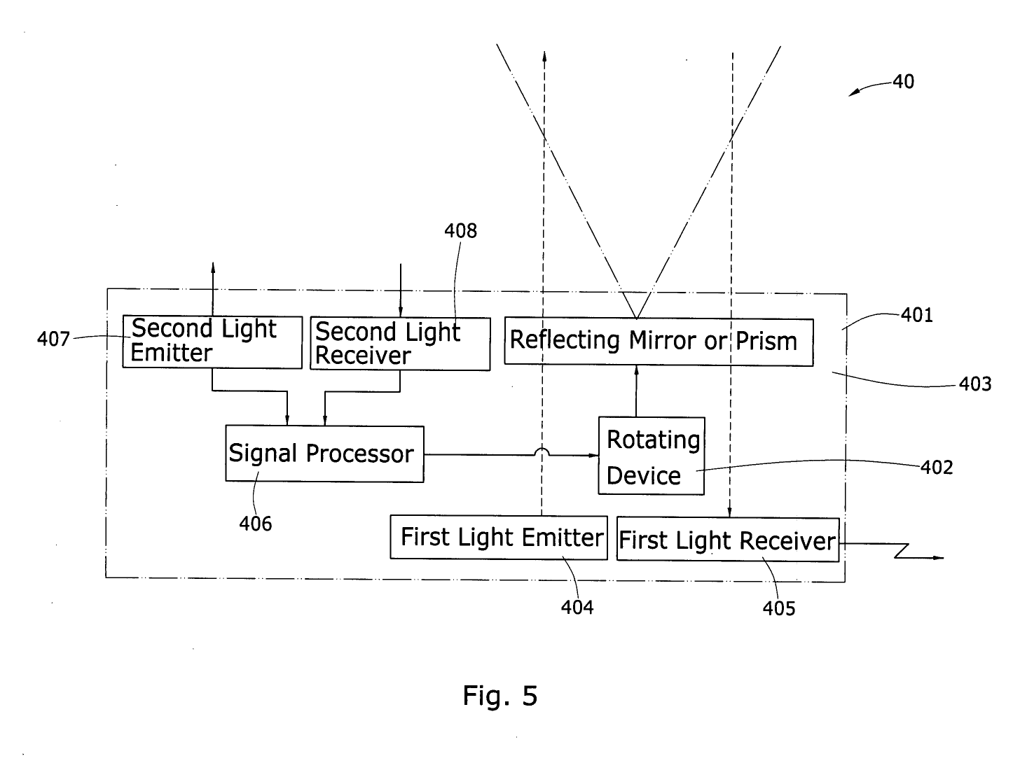

Referring to FIG. 5, it shows a hardware block diagram of another preferred embodiment of the present invention, wherein to further increase convenience in assembling, the aforementioned laser barcode scanner 40 comprises primarily a housing 401, a rotating device 402, which is assembled inside the housing 401 at a position corresponding to the aforementioned through-hole 4011 of the housing 401, to generate power for rotating back and forth; a reflecting mirror or prism 403, which is assembled on the aforementioned rotating device 402 to rotate back and forth along with the rotating device 402, and is provided with a light refraction effect such that light from a same direction can be refracted into the light at a different angle; a first light emitter 404, which is assembled at a rear side of the reflecting mirror or prism 403, and is an ordinary laser point source or an infrared source to emit the aforementioned scanning light; a first light receiver 405, which is assembled at a side of the light emitter 404, is a photo diode, and is used to receive the aforementioned scanning light that has been reflected by the barcode 50 for decoding the barcode 50; a signal processor 406, which is assembled at a side of the rotating device 402; and a second light emitter 407 and a second light receiver 408, which are assembled at a side of the signal processor 406, with the signal processor 406 linking data with the second light emitter 407, the second light receiver 408, and the rotating device 402. The second light emitter 407 can emit a ranging light to the aforementioned barcode 50 and output an electronic signal to the signal processor 406; whereas, after the second light receiver 408 has received the reflected ranging light, an electronic signal can be outputted to the signal processor 406 to measure the distance-related information which is converted into a related electronic signal and is then inputted into the rotating device 402 for controlling a rotation angle thereof. On the other hand, a circuit device of the laser barcode scanner 40 can be also assembled with a light intensity compensation IC (not shown in the drawing), such that when the operating distance is farther, the first light emitter 404 or the auxiliary second light emitter 407 can be activated to generate light compensation by using a pre-built parametric value of the light intensity compensation IC, so as to keep an effective operation. On the contrary, if the distance is too close, the light intensities of the first light receiver 404 and the second light receiver 407 can be adjusted by the pre-built parametric value of the light intensity compensation IC, to save the power.

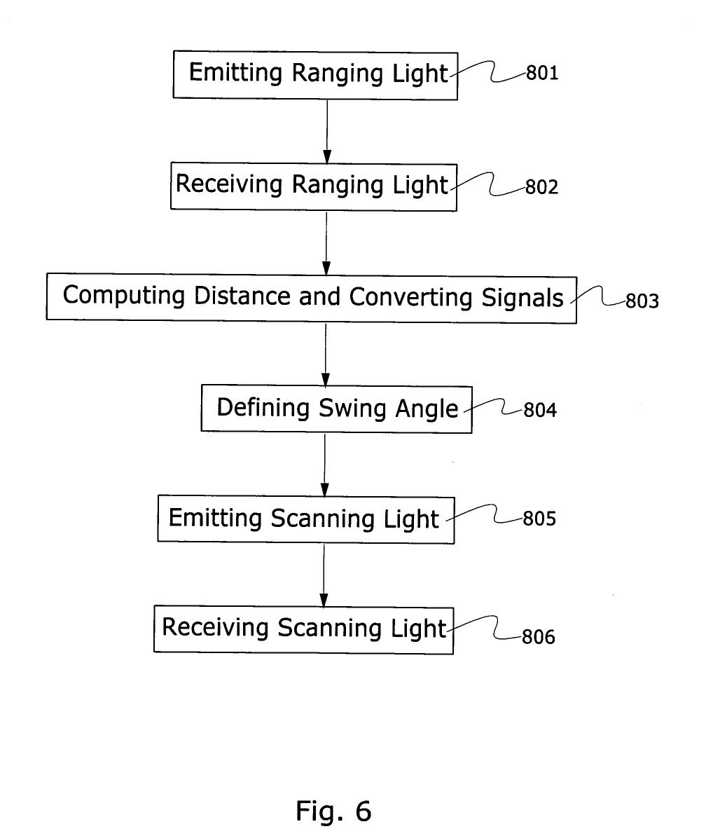

Referring to FIG. 6, it shows a flow diagram of steps of another preferred embodiment of the present invention, wherein the steps of an execution method thereof include:

A first step 801—emitting a ranging light, a ranging light is emitted to the barcode by the second light emitter through the reflecting mirror or prism, and an electronic signal is issued to the signal processor, then, when the light hits the barcode, the aforementioned ranging light will be reflected immediately;

A second step 802—receiving the ranging light, the aforementioned ranging light, which has been reflected by the barcode, is received by the second light receiver, and an electronic signal is similarly issued to the signal processor;

A third step 803—computing the distance and converting the signals, after the signal processor has received the electronic signals of the second light emitter and the second light receiver, a distance-related information between the barcode and the laser barcode scanner will be computed, and converted into an electronic signal representing a time difference between the two electronic signals;

A fourth step 804—defining a swing angle, after the aforementioned distance-related electronic signal has been inputted into the rotating device, a value of a rotation angle of the rotating device can be defined to control the angle at which the rotating device is rotating back and forth;

A fifth step 805—emitting a scanning light, a light for scanning the barcode is emitted by the first light emitter again, and is projected on the reflecting mirror or prism which swings back and forth; and

A sixth step 806—receiving the scanning light, the scanning light which has been reflected by the barcode can be received again by the first light receiver to access a barcode data.

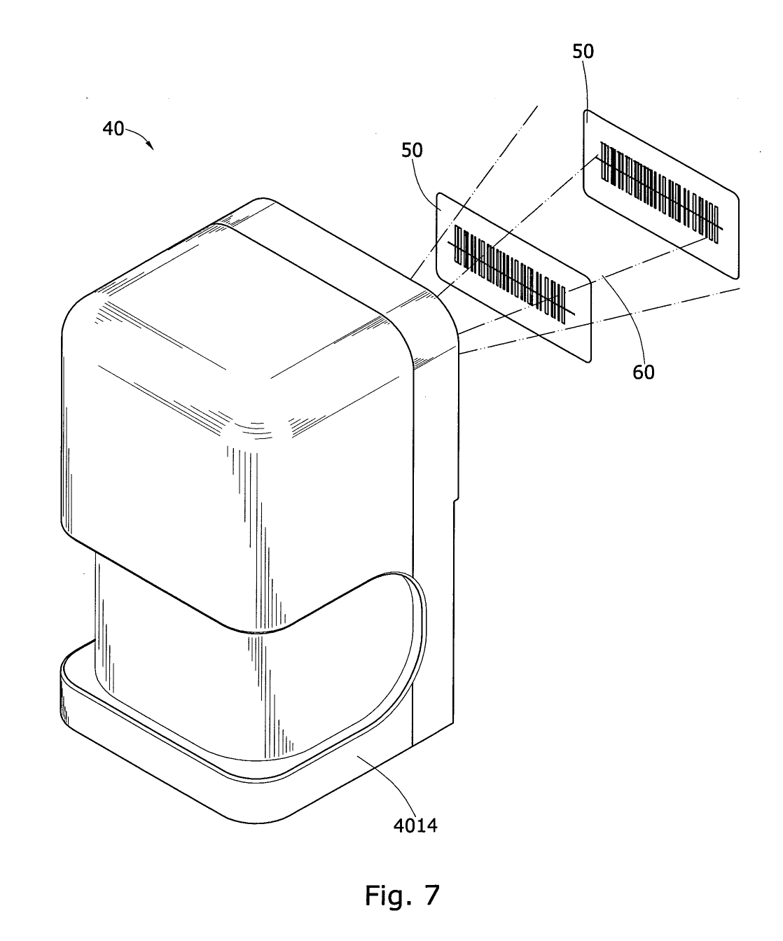

Referring to FIG. 7, it shows a schematic view upon using another preferred embodiment of the present invention, wherein taking an ordinary seat-type laser barcode scanner 40 as an example, the seat-type laser barcode scanner 40 is fixed on a plane, and angles at which a ranging light and a scanning light 60 are emitted can be adjusted by a bottom seat 4014 with a changeable inclination angle and a changeable rotation angle, to facilitate the user to adjust an angle for accessing the barcode 50. Although the laser barcode scanner 40 of this preferred embodiment is fixed, the width of the scanning light 60 can be still changed dependent on the distance for accessing the barcode 50.

Accordingly, upon implementing the present invention, the ranging light is first emitted by the first light emitter or the second light emitter; whereas, the resulted first electronic signal, and the second electronic signal which is resulted after the reflected ranging light has been received by the first light receiver or the second light receiver, are computed by the signal processor to obtain the time difference between the two electronic signals, so as to result in the third electronic signal related to the distance, which is then inputted into the rotating device to define the rotation angle. In addition, the rotating angle can be also changed at any time dependent on the distance, so as to accurately provide a laser barcode scanner and an execution method thereof, for automatically adjusting the intensity and the width of the scanning light, thereby improving the access efficiency.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A laser barcode scanner and an execution method thereof, with the execution method comprising:
a first step—emitting a ranging light, a ranging light being emitted to a barcode by a first light emitter through a reflecting mirror or prism, and an electronic signal being issued to a signal processor, then, when the light hits the barcode, the ranging light being reflected immediately;
a second step—receiving the ranging light, the ranging light, which has been reflected by the barcode, being received by a first light receiver, and an electronic signal being similarly issued to the signal processor;
a third step—computing the distance and converting the signals, after the electronic signals of the first light emitter and the first light receiver have been received by the signal processor, a distance-related information between the barcode and the laser barcode scanner being computed and converted into an electronic signal representing a time difference between the two electronic signals;
a fourth step—defining a swing angle, after the distance-related electronic signal has been inputted into a rotating device, a rotation angle of the rotating device being defined, to control an angle at which the rotating device is rotating back and forth;
a fifth step—emitting a scanning light, the first light emitter emitting a light again, which is projected on the reflection mirror or prism that is rotating back and forth, to result in the scanning light on the barcode; and
a sixth step—receiving the scanning light, the scanning light, which has been reflected by the barcode, being received by the first light receiver to access a barcode data.

2. The laser barcode scanner and an execution method thereof, according to claim 1, wherein a width of the scanning light beam is diminished as the distance gets farther.

3. The laser barcode scanner and an execution method thereof, according to claim 1, wherein a distance between the barcode and the laser barcode scanner is converted into an electronic signal related to the distance, to control a swing angle of the reflecting mirror or prism.

4. A laser barcode scanner and an execution method thereof, with the laser barcode scanner comprising a housing which is formed with a through-hole; a rotating device which is assembled inside the housing; a reflecting mirror or prism which is assembled on the rotating device and is rotating back and forth along with the rotating device; a first light emitter, which is assembled at a rear side of the reflecting mirror or prism, emits a light to the reflecting mirror or prism, and generates an electronic signal; a first light receiver, which is assembled at a side of the first light emitter, receives the light that is reflected by the barcode, generates another electronic signal, and decodes the barcode; and a signal processor, which is assembled at a side of the first light emitter, and links data with the first light emitter, the first light receiver, and the rotating device, such that the electronic signals of the first light emitter and the first light receiver are inputted into the signal processor for computing and conversion, and thereby driving the rotating device to rotate back and forth.

5. The laser barcode scanner and an execution method thereof, according to claim 4, wherein the first light emitter is a laser point source.

6. The laser barcode scanner and an execution method thereof, according to claim 4, wherein the first light emitter is an infrared source.

7. The laser barcode scanner and an execution method thereof, according to claim 4, wherein the first light receiver is a photo diode.

8. The laser barcode scanner and an execution method thereof, according to claim 4, wherein a side of the signal processor is further assembled with a second light emitter and a second light receiver, with the second light emitter emitting a ranging light and outputting an electronic signal to the signal processor, the second light receiver receiving the reflected ranging light and outputting an electronic signal to the signal processor, and the signal processor linking data with the rotating device.

9. The laser barcode scanner and an execution method thereof, according to claim 8, wherein the execution method comprises a first step—emitting a ranging light, a ranging light being emitted to a barcode by the second light emitter through the reflecting mirror or prism, and an electronic signal being issued to the signal processor, then, when the light hits the barcode, the ranging light being reflected immediately;
a second step—receiving the ranging light, the ranging light, which has been reflected by the barcode, being received by the second light receiver, and an electronic signal being similarly issued to the signal processor;
a third step—computing the distance and converting the signals, after the electronic signals of the second light emitter and the second light receiver have been received by the signal processor, a distance-related information between the barcode and the laser barcode scanner being computed and converted into an electronic signal representing a time difference between the two electronic signals;
a fourth step—defining a swing angle, after the distance-related electronic signal has been inputted into the rotating device, a rotation angle of the rotating device being defined, to control an angle at which the rotating device is rotating back and forth;
a fifth step—emitting a scanning light, the first light emitter emitting a light, which is projected on the reflection mirror or prism that is rotating back and forth, to result in the scanning light on the barcode; and
a sixth step—receiving the scanning light, the scanning light, which has been reflected by the barcode, being received by the first light receiver to access a barcode data.

10. The laser barcode scanner and an execution method thereof, according to claim 4, wherein a circuit device of the laser barcode scanner is assembled with a light intensity compensation IC (Integrated Circuit).
